(19) United States
(12) Patent Application Publication
(10) Pub. No.: US 2002/0087828 A1
(43) Pub. Date: Jul. 4, 2002

(54) Symmetric multiprocessing (SMP) system with fully-interconnected heterogenous microprocessors

(75) Inventors: Ravi Kumar Arimilli, Austin, TX (US); David William Siegel, Austin, TX (US)

Correspondence Address: Andrew J. Dillon, FELSMAN, BRADLEY, VADEN, GUNTER & DILLON, LLP, Lakewood on the Park, Suite 350, 7600B North Capital of Texas Highway, Austin, TX, 78731, US

(73) Assignee: International Business Machines Corporation

(21) Appl. No.: 09/753,052

(22) Filed: Dec. 28, 2000

(51) Int. Cl. G06F 15/00

(52) U.S. Cl. 712/32

(57) ABSTRACT

Disclosed is a fully-interconnected, heterogenous, multiprocessor data processing system. The data processing system topology has a plurality of processors each having unique characteristics including, for example, different processing speeds (frequency) and different cache topologies (sizes, levels, etc.). Second and third generation heterogenous processors are connected to a specialized set of pins, connected to the system bus. The processors are interconnected and communicate via an enhanced communication protocol and specialized SMP bus topology that supports the heterogeneous topology and enables newer processors to support full downward compatibility to the previous generation processors. Various processor functions are modified to support operations on either of the processors depending on which processor is assigned which operations. The enhanced communication protocol, operating system, and other processor logic enable the heterogenous multiprocessor data processing system to operate as a symmetric multiprocessor system.

### BACKGROUND OF THE INVENTION

1. Field of the Invention:

The present invention relates in general to data processing systems and, more particularly, to an improved multiprocessor data processing system topology. Still more particularly, the present invention refers to a method for implementing a data processing system topology with fully-interconnected heterogenous processors, caches, memory, etc. operating as a symmetric multiprocessor system.

2. Description of the Related Art:

Trends towards increased performance of computer systems often focuses on providing faster, more efficient processors. Traditional data processing systems typically include a single processor interconnected by a system bus with memory and I/O components and other processor components. Initially, to meet the need for faster processor speeds, most computer system users purchased new computers with a faster processor chip. For example, an individual user running a 286 microprocessor system would then purchase a 386 or 486 system and so on. Today in common technology terms, the range of processor speeds is described with respect to the Pentium I, II, or III system, which operate at processor speeds in the gigahertz range.

As technology improved, and the need for faster and more efficient data processing systems increased, the computer industry has moved towards multiprocessor systems in which the single processor data processing systems are replaced with multiple homogenous processors connected on a system bus. Thus, current designs of computer systems involve coupling together several homogenous processors to create multi-processor data processing systems (or symmetric multiprocessor (SMP) data processing systems). Also, because of silicon technology improvements, chip manufacturers have begun integrating multiple homogenous processors on a single processor chip providing second generation multiprocessor systems. The typical SMP, or multiprocessor system, consists of two or more homogenous processors operating with similar processing structure and at the same speed, and with similar memory and cache topologies.

Another factor considered in improving efficiency of a data processing system is the amount of memory available for processing instructions. The virtual memory on the computer includes memory modules such as DIMMs and SIMMs. These memory modules have progressed from 2 megabytes to 4 megabytes to 32 megabytes, and so on. Current end user systems typically include between 64 megabytes of memory to 128 megabytes of memory. In most systems, the amount of memory is easily upgradable by adding on another memory module to the existing one(s). For instance, a 32 megabyte memory module may be added to the motherboard of a computer system that has 32 megabytes of memory to provide 64 megabytes of memory. Typically, consistency in the type of memory module utilized is required, i.e., a system supporting DIMM memory modules can only be upgraded with another DIMM module, whereas a system supporting SIMM memory modules can only be upgraded with another SIMM memory module. However, within the same memory module group, different size of memory modules may be placed on the motherboard. For example, a motherboard with 32 megabyte of DIMM memory may be upgraded to a 96 megabyte by adding a 64 megabyte DIMM memory module.

Developers are continuously looking for ways to improve processor efficiency and increase the amount of processor power available in systems. There is some discussion within the industry of creating a hot-pluggable type processor whereby another homogeneous processor may be attached to a computer system after design and manufacture of the computer system. Presently, there is limited experimentation with the addition of homogeneous processors because adding an additional processor after design and manufacture is a difficult process since most systems are created with a particular processor group and an operating system designed to only operate with the particular configuration of that processor group.

Thus, if a user is running a one megahertz computer system and wishes to have a more efficient system, he may be able to add another 1 megahertz processor. However, assuming the user wishes to upgrade to a 2 megahertz or 3 megahertz system, he must purchase an entire computer system with the desired processor and system characteristics. Purchasing an entirely new system involves significant expense for the user who already has a fully functional system. The problem is even more acute with high-end users who require their system to be fully functionally on a continuous basis (i.e., 24 hours a day, 7 days a week) but wish to upgrade their present system to include a processor with the desired characteristics. Users today will typically “cluster” these machines together over an industry standard network. The high-end user has to find some way of obtaining the benefits of the technologically-improved processor architectures without incurring significant down time, loss of revenues, or additional computer system costs.

The present invention recognizes that it would therefore be desirable and advantageous to have a data processing system topology which allows for adding heterogenous processors to a processing system to keep up with technological advancements and needs of the user of the system without significant re-configuration of the prior processing system. A data processing system that enables a user to upgrade to newer, more efficient processor and cache topologies and which operates as a symmetric multiprocessor (SMP) system would be a welcomed improvement. These and other benefits are provided in the invention described herein.

### SUMMARY OF THE INVENTION

Disclosed is a fully-interconnected, heterogenous, multiprocessor data processing system. The data processing system topology has a plurality of processors each having unique characteristics including, for example, different processing speeds (frequency), different integrated circuit design, different cache topologies (sizes, levels, etc.). The processors are interconnected via a system bus or switch and communicate via an enhanced communication protocol that supports the heterogeneous topology and enables each processor to process data and operate at their respective frequencies.

Second and third generation heterogenous processors are connected to a specialized set of pins, connected to the system bus that allow the newer processors to support enhanced system bus protocols with downward compatibility to the previous generation processors. Various processor functions are modified to support operations on either of the processors depending on which processor is assigned which operations. The enhanced communication protocol, operating system, and other processor logic enable the heterogenous multiprocessor data processing system to operate as a symmetric multiprocessor system.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a block diagram of a conventional multiprocessor data processing system with which the preferred embodiment of the present invention may be advantageously implemented;

FIG. 2 depicts a multiprocessor data processing system similar to FIG. 1, with connectors for connecting additional processors to a system bus in accordance with one embodiment of the present invention;

FIG. 3 depicts the resulting heterogenous multiprocessor configuration after connecting additional heterogenous processors to system bus of FIG. 2 in accordance with one embodiment of the present invention;

FIG. 4 depicts a second generation heterogenous multiprocessor topology in accordance with one embodiment of the present invention;

FIG. 5 depicts a four processor chip heterogenous multiprocessor having a distributed and integrated switch topology and distributed memory and I/O in accordance with one preferred embodiment of the present invention; and

FIG. 6 depicts an illustrative SMP system bus as utilized to provided extended services to extended processors within a heterogenous multiprocessor topology in accordance with one embodiment of the present invention;

### DESCRIPTION OF THE PREFERRED EMBODIMENT

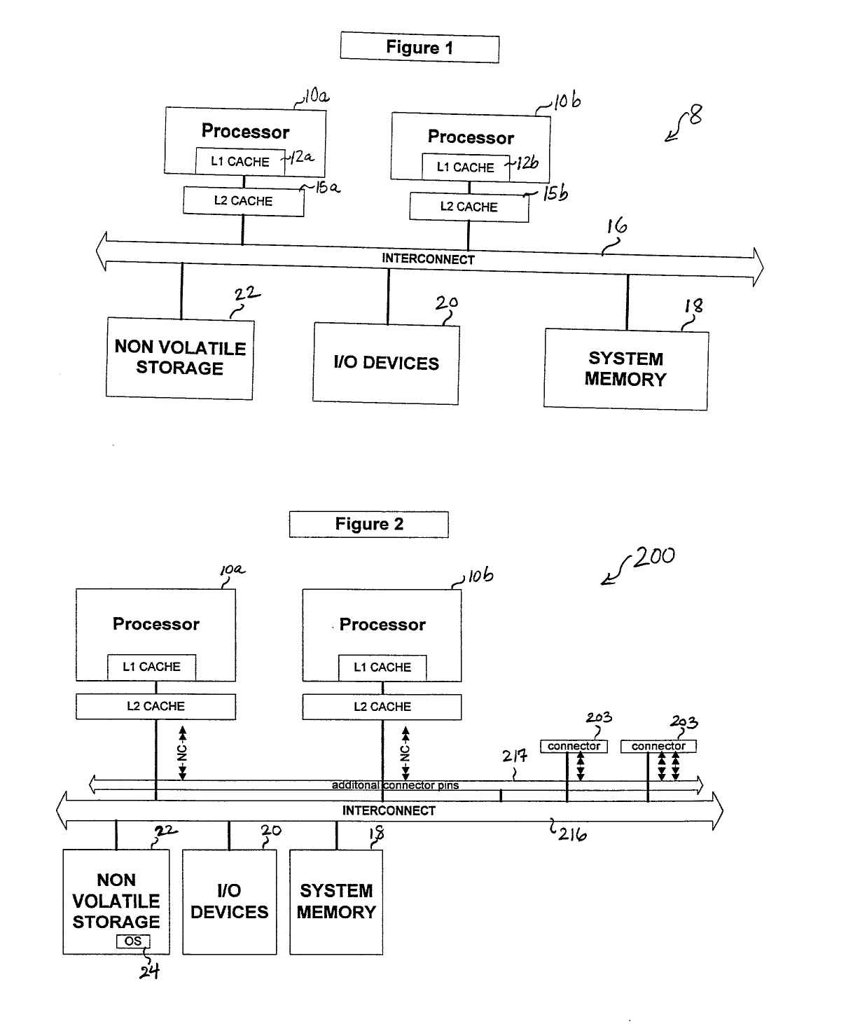

With reference now to the figures, and in particular with reference to FIG. 1, there is illustrated a high level block diagram of a multiprocessor data processing system with which a preferred embodiment of the present invention may advantageously be implemented. As depicted, data processing system 8 includes two processors 1Oa, lOb, which may operate according to reduced instruction set computing (RISC) techniques. Processors 1Oa, lOb may comprise one of the PowerPC™ line of microprocessors available from International Business Machines Corporation; however, those skilled in the art will appreciate that other suitable processors can be utilized. In addition to the conventional registers, instruction flow logic, and execution units utilized to execute program instructions, each of processors 1Oa, lOb also includes an associated one of on-board level-one (L1) caches 12a, 12b, which temporarily store instructions and data that are likely to be accessed by the associated processor. Although L1 caches 12a, 12b are illustrated in FIG. 1 as unified caches that store both instruction and data (both referred to hereinafter simply as data), those skilled in the art will appreciate that each of L1 caches 12a, 12b could alternatively be implemented as bifurcated instruction and data caches.

In order to minimize latency, data processing system 8 may also include one or more additional levels of cache memory, such as level-two (L2) caches 15a-15b, which are utilized to stage data to L1 caches 12a, 12b. L2 caches 15a, 15b are positioned on processors 1Oa, 10b. L2 caches 15a-15b are depicted as off-chip although it is possible that they may be on-chip. L2 caches 15a, 15b can typically store a much larger amount of data than L1 caches 12a, 12b (eg. L1 may store 32 kilobytes and L2 512 kilobytes), but at a longer access latency. Thus, L2 caches 15a, 15b also occupy a larger area when placed on-chip. Those skilled in the art understand that although the embodiment described herein refers to an L1 and L2 cache, various other cache configurations are possible, including a level 3 (L3) and level 4 (L4) cache configuration and additional levels of internal caches as provided below. Processors 1Oa, lOb (and caches) are homogenous in nature, i.e., they have common topologies, operate at the same frequency (speed), have similar cache structures, and process instructions in a similar fashion (e.g., fully in-order).

As illustrated, data processing system 8 further includes input/output (I/O) devices 20, system memory 18, and non-volatile storage 22, which are each coupled to interconnect 16. I/O devices 20 comprise conventional peripheral devices, such as a display device, keyboard, and graphical pointer, which are interfaced to interconnect 16 via conventional adapters. Non-volatile storage 22 stores an operating system and other software, which are loaded into volatile system memory 18 in response to data processing system 8 being powered on. Of course, those skilled in the art will appreciate that data processing system 8 can include many additional components which are not shown in FIG. 1, such as serial and parallel ports for connection to network or attached devices, a memory controller that regulates access to system memory 18, etc.

Interconnect 16, which may comprise one or more buses or a cross-point switch, serves as a conduit for communication transactions between processors lOa-lOb, system memory 18, I/O devices 20, and nonvolatile storage 22. A typical communication transaction on interconnect 16 includes a source tag indicating the source of the transaction, a destination tag specifying the intended recipient of the transaction, an address and/or data. Each device coupled to interconnect 16 preferably monitors (snoops) all communication transactions on interconnect 16.

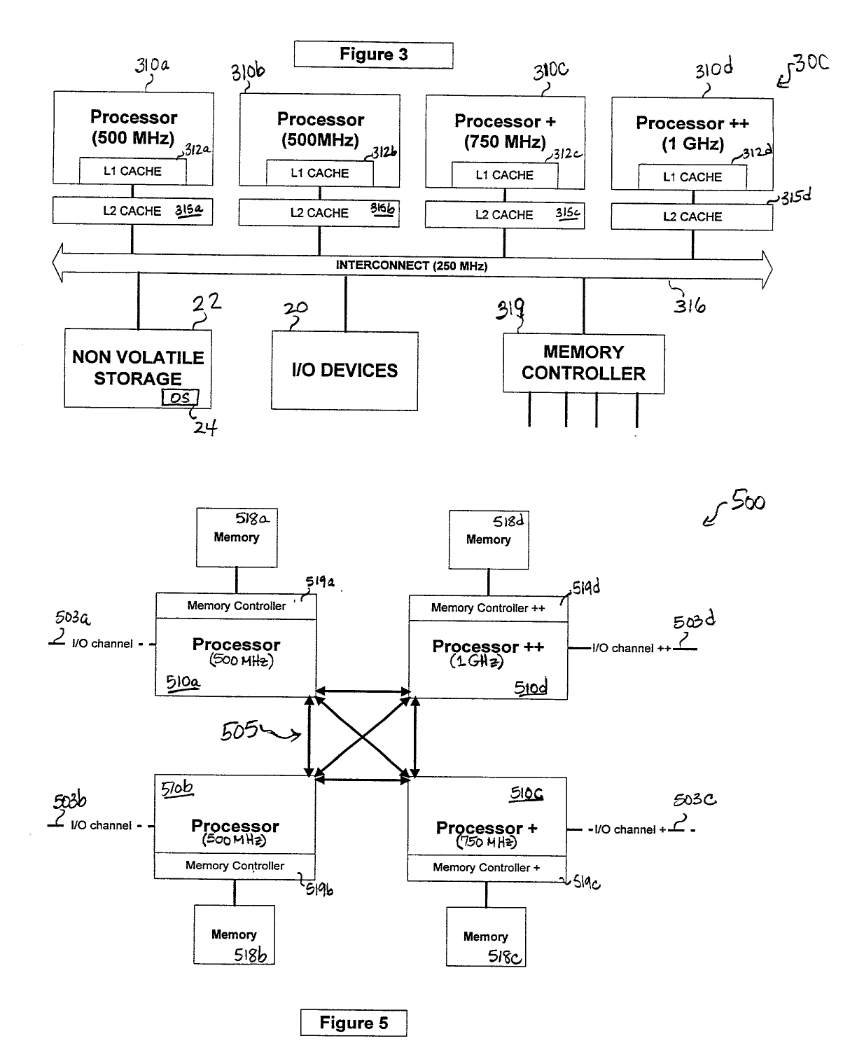

Referring now to FIG. 2, there is illustrated a data processing system 200 similar to that of FIG. 1 with additional pins 217 and connector ports 203 coupled to interconnect 216. Other components of data processing system of FIG. 2 and FIG. 3, which are similar to components of data processing system 100 of FIG. 1 will not be described but are illustrated by associated reference numerals. Additional pins 217 allow other processors to be connected to data processing system 200. As illustrated, processors lOa, lOb are not connected to additional pins 217. During manufacture of data processing system 200, initial processors are provided with only the required system bus connections and thus do not utilize additional pins 217. Connector ports 203 provide a docking mechanism on the data processing motherboard at which additional heterogenous (or homogenous) processors may be connected via processor connection pins. Thus, connector ports 203 are designed to take each of these pins and connect them to the associated system connectors via additional pins 217. Also illustrated in FIG. 2 is operating system 24 (or firmware), located within non-volatile storage 22. Operating system controls the basic operations of data processing system 200 and is modified to provide support for heterogeneous multiprocessor topologies utilizing an enhanced bus protocol.

FIG. 3 illustrates the data processing system of FIG. 2 with two additional processors connected to interconnect 316 via connector port 203 or other communication medium and memory controller 319 also connected to interconnect 316. Thus, the FIG. 3 topology includes processor A 310a and processor B 310b, and additional processor C 310c and processor D 310d. Processors C 310c and processor D 310d are labeled processor + and processor ++, indicating that processor C 310c comprises improvements over processors A and B 310a, 310b and processor D 310d comprises additional improvements over processor C 310c. For example, the improved processors may be designed with better silicon integration, additional execution units, deeper processor pipelines, etc., operate at higher frequencies, operate with more efficient out-of-order instruction processing, and/or provide different cache topologies. Processor C 310c and processor D 310d may be connected to data processing system via, for example, connector ports 203 of FIG. 2. Thus, according to FIG. 3, a heterogeneous processor system is implemented whereby heterogenous processors are placed on the same interconnect 316 and made to operate simultaneously within data processing system 300 as a symmetric multiprocessor system. Simultaneous operation of the heterogeneous processors requires additional software and hardware logic, which is provided by operating system 24 and enhanced bus protocols, etc.

Another consideration is the amount of pre-fetch of each processor. The depth of the processor pipeline tends to be greater as the generation of the processor increases and thus, pre-fetch state in a higher generation processor may include larger amounts of data than those in the lower generation processors.

FIG. 3 provides a first and second generation heterogeneous upgrade, with each generation represented by a different processor and cache topology. As illustrated, processor C 310c and processor D 310d each operate at a different frequency. Each processor is connected via interconnect 316, which may also operate at a different frequency. Because of the frequency differences possible in the processor and cache hardware models all connected to an interconnect 316 with a set frequency, the processing system's communication protocols are enhanced to support different ratios of frequency. Thus, the frequency ratios between the processors, the caches, and the interconnect 316 is N:M, where N and M may be different integers. For example, the frequency ratios may be 2:1, 3:1, 4:1, 5:2, 7:4, etc. The second generation upgrade heterogeneous system illustrated in FIG. 3 provides a 2:1, 3:1, 4:1 ratio with the regards to the processor frequencies versus the frequency of interconnect 316. As illustrated, interconnect 316 operates at 250 megahertz (MHz), processor A 310a and processor B 310b operate at a 500 megahertz frequency, and processor C 310c and processor D 310d operate at 2 gigahertz (GHz) and 3 Ghz, respectively. Of course, the processor frequency may be asynchronous with the interconnect's frequency whereby no whole number ratio can be attributed.

Operating system 24 illustrated in non-volatile storage 22 is a modified operating system designed to operate within a data processing system comprising heterogeneous processors. Operating system 24 operates along with other system logic and communication protocols to provide support required for heterogenous processors exhibiting differences in design, operational characteristics, etc. to operate simultaneously.

In the heterogeneous data processing system, the heterogeneity typically extends to the processor's micro architectures, i.e., the execution blocks of the processor, the FXU, FPU, ISU, LSU, IDUs, etc., are designed to support the operational characteristics associated with the processor. Additionally, heterogeneity also extends to the cache topology including different cache levels, cache states, cache sizes, and shared caches. Heterogeneity would necessarily extend to the memory controllers micro-architecture and memory frequency and the I/O controller micro-architecture and I/O frequencies. Also heterogeneity supports processors operating with in-order execution, some out-of-order execution, or robust out-of-order execution.

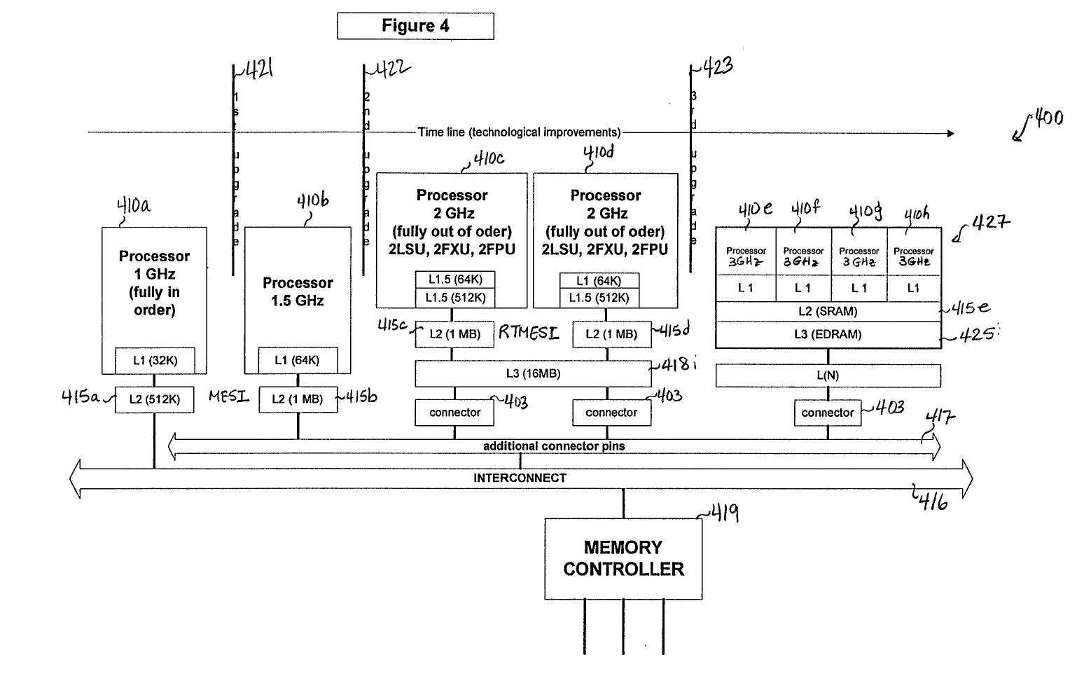

Referring now to FIG. 4, there is illustrated a first and second upgrade heterogenous multiprocessor data processing system with an associated upgrade timeline. FIG. 4 illustrates a first time period 421, second time period 422, and third time period 423 at which new processor(s) are added to data processing system. Each time period may correspond to a time in which improvements are made in technology, such as advancements in silicon integration, which results in a faster, more efficient processor topology that includes different cache topology and associated operational characteristics.

Unlike the topology of FIG. 3 in which processor C 310c and processor D 310d are illustrated added directly to interconnect 316, the system planar of FIG. 4 provides a separate interconnect 417, described in FIG. 2 above, comprised of reserve pins for connecting interrupts of the new processors. Interconnect 417 allows new processors to compete cache intervention and other inter-processor operations but will support full compatibility of the previous generation processors.

Interrupt pins of interconnect 417 are provided with the initial system planar to support later addition of processors. Each new additional processor utilizes a different number of interrupt pins. For example, a first upgrade heterogenous processor may utilize three interrupt pins while a third upgrade heterogenous processor may utilize eight interrupt pins.

Initially data processing system 400 may comprise processors A 1OA as illustrated in FIG. 2. After the first time period 421, processor B 410b is added to interconnect 417. Processors B 410b operates at 1.5 GHz compare to the 1 Ghz operation of processor A 410a. L1 cache and L2 cache of processor B 410b are twice the size of corresponding caches on processor A 410a.

At second time period 422, processors C and D 410c, 410d are connected to interconnect 417. New processors C and D 410c, 410d operate at 2 Ghz and provides fully out-of-order processing. Additionally, processors C and D 410c, 410d each include pairs of execution units, bifurcated on-chip L1 caches, an L2 cache, and a shared L3 cache 418.

A third time period 423 may provide processors that operate with simultaneous multithreading (SMT), which allows simultaneous operation of two or more processes on a single processor. Thus, the third generation heterogenous processors 427 may comprise a four-way processor chip 410e-410h operating as an eight-way processor. Third generation heterogenous processors 427 may also comprise increased numbers of level caches (L1-LN) and very large caches through integrated, enhanced DRAMs (EDRAM) 425.

The migration across the time periods are due in part to silicon technology improvements, which allow a lower cost and increased processor frequency. Additionally the operational characteristics of the processors are themselves being improved upon and include improved cache states (i.e., cache coherency mechanisms, etc.), and improved processor architecture. Also enhancements in the system bus protocols are made to extend the system bus (coherency) protocols to support full downward compatibility amongst the previous generation processors. The enhanced bus protocol may be provided as a superset of the regular bus protocol.

### Cache Transactions

As each new processor is added to the data processing system, the system logs information about the new processor including the processor's operational characteristics, cache topologies, etc., which is then utilized during operation to enable correct interactions with other components and more efficient processing, i.e., sharing and allocation of work among processors. An evaluation of the data processing system may be performed by operating system 24, which then provides a system centric enhancements related to cache intervention, pre-fetching, intelligent cache states, etc., in order to optimize the results of these operations.

For example, a lower speed first generation processor may only include the MESI cache state, whereas the faster second generation processor may include an additional two cache states such that its cache states are the RTMESI cache states. Processor designs utilizing RTMESI cache states are described in U.S. Pat. No. 6,145,059, which is hereby incorporated by reference. When bus transactions are issued by the faster second generation processor, they are optimized for the second generation initially (i.e., RTMESI). However, if the snoop hits on a lower generation processor cache, then the second generation processor is signaled and the bus transaction is completed without the RT cache states (i.e., as a MESI state). Thus, each processor initially optimizes processes for its own generation.

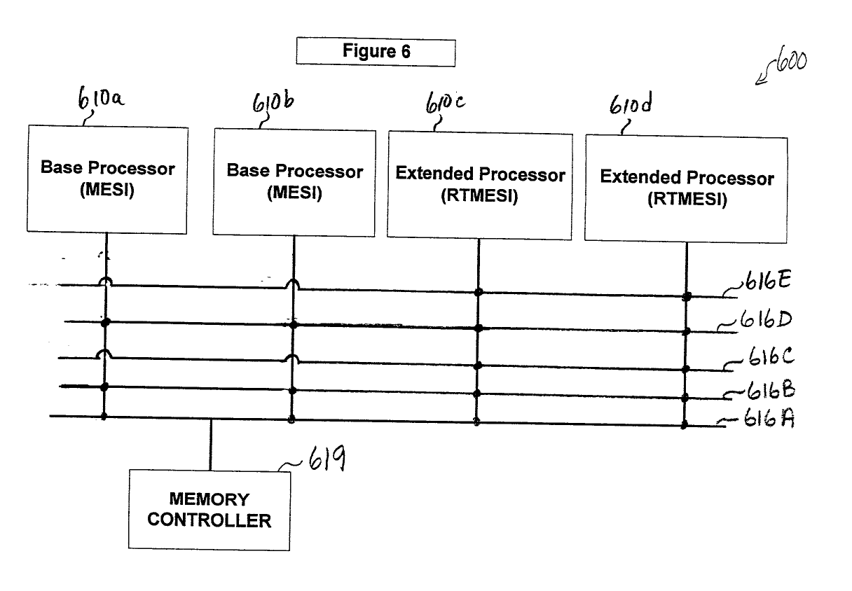

Referring now to FIG. 6, a system bus topology to support cache transactions of extended processors (i.e., higher generation processors) of a heterogenous multiprocessor system 600 is provided in accordance with one embodiment of the invention. SMP bus topology comprises five (5) buses (pins) that provide interconnection amongst system components. The buses are system data bus 616A, base address bus 616B, master processor select bus (pins) 616C, base snoop response bus 616D, and extended snoop response bus 616E. Master processor select bus 616C comprises pins connected to extended processors that takes an active state when the particular extended processor is operating as the master on the bus.

Connected to SMP system buses are four processors. Base processors 601a, 610b, which may be similar to processor 410a of FIG. 4, operate with MESI cache states. Base processors are connected to the standard buses, i.e., system data bus 616A, base address bus 616B, and base snoop response bus 616D. Extended processors 610c, 610d operate with RTMESI cache states and are connected to the three standard buses and also to the two buses that support extended operations, i.e., extended snoop response bus 616E and master processor select bus 616C.

During operation, when either of base processors 610a, 610b is master, the system operates normally since the base processors 610a, 610b are able to snoop MESI cache states of extended processors with standard system bus protocols. When one of extended processors 610c, 610d is selected as a master on the bus, e.g., extended processor 610c the master processor select pin 616c is driven to an active state. The extended processor 610c does not know if the other processors operate with RTMESI or MESI cache state. Thus, once extended processor 610c becomes the master, extended processor 610c indicates to other extended processors 610d via master processor select pin 616C that it is an extended processor.

When a read (address) is issued by the extended processor 610c, the master select pin for that processor is activated. The other extended processor 610d snoops the read transaction and recognizes that the master is also an extended processor because of the activated master select pin 616C. Knowing that the master is extended, the other extended processor 610d, which is in the R cache state, drives the extended snoop response bus 616E with shared intervention information. Also, extended the snooper (extended processor 610d) sends a snoop retry on base snoop response bus 616D. The master then consumes the shared intervention data from the other extended processor and moves from I to R state. The extended snooper then moves from R to S state.

When the read bus transaction is initially issued, the memory controller begins to speculatively read memory for the data. However, if a subsequent retry is seen on the bus, the memory controller immediately ignores the read operation. One result of the above operation by the extended processor during shared intervention is improved latency for cache reads through the extended processors. Also, the memory controller has an improved performance because its availability is increased. The retry issued on base snoop response bus 616D allows the memory controller to immediately stop the previous snoop and accept other memory transactions.

The extended processor's operations are supported by an extended (enhanced) bus protocols, which allows the extended processors 610c, 610d to communicate with each other and still provide downward compatibility with base processors 610a, 610b, and memory controller 619.

Inherently, the functionality of extended bus protocols also supports multiple sizes cache lines. Thus, extended processors 610c, 610d may have larger cache lines for improved performance. To support cache transactions with base processors 610a, 610b, which typically have smaller cache lines, the large cache lines of the extended processors 610c, 610d are sectored. Thus, sectoring of the larger cache lines allows the extended processor to transfer large cache lines to another extended processor via extended snoop bus 616E as multiple sectors. When communicating with base processors, however, extended processors 610c, 610d are able to transfer single sectors at a time.

Traditional data processing systems were designed with single processor chips having one or more central processing units (CPU) and a tri-state multi-drop bus. With the fast growth of multi-processor data processing systems, building larger scalable SMPs requires the ability to hook up multiple numbers of these chips utilizing the bus interface.

Providing multiprocessor systems with multiple processor chips places a significant burden on the traditional interconnect. Thus, present systems utilize a direct interconnect or switch topology by which the processors communicate directly with each other as well as with the memory and input/output and other devices. These configurations allow for a distributed memory and distributed input/output connections, and provides support for the heterogenity among the connected processors. Switch topologies provide faster/direct connection between components leading to more efficient and faster processing.

With reference now to FIG. 5, there is illustrated a switch connected multichip topology of a multiprocessor system with second generation upgrade heterogeneous processors. The data processing system includes processor A 510a and processor B 510b which are homogenous. Additionally, the data processing system includes processor C 510c and processor D 510d each providing different (upgraded) operational characteristics. Within each processor, is a memory controller 519a-519d. As illustrated, memory controller may also exhibit unique operational characteristics depending on which processor it supports. However, memory controller 517a-517d may be off-chip components with unique operating characteristics. Memory controller 517a-517d controls access to distributed memory 518a-518d of data processing system.

Also indicated are input/output (I/O) channels 503a-503d which connect processor 517a-517d respectively to input/output devices. Input/output channels 503a-503d may also provide different types of connectivity. For example, input/output channel 503c may connect to I/O devices at a higher frequency than input/output channel 503b, and input/output channel 503d may connect to I/O devices at an even higher frequency than input/output channels 503a-503c. The operational characteristics of input/output channels 503a-503d and memory controllers 517a-517d are preferably correlated to the operational characteristics or needs of the associated processors 510a-510d.

As a final matter, it is important to note that while an illustrative embodiment of the present invention has been, and will continue to be, described in the context of a fully functional data processing system, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analog communication links.

Although the invention has been described with reference to specific embodiments, this description is not meant to be construed in a limiting sense. Various modifications of the disclosed embodiment, as well as alternative embodiments of the invention, will become apparent to persons skilled in the art upon reference to the description of the invention.

What is claimed is:

1. A data processing system comprising:
a first processor with a first operational characteristics on a system planar;
interconnection means for later connecting a second, heterogenous processor on said system planar, wherein said interconnection means enables said first processor and said second, heterogenous processor to collectively operate as a symmetric multiprocessor (SMP) system.

2. The data processing system of claim 1, further comprising a second, heterogenous processor connected to said system bus via said interconnect means, wherein said second, heterogenous processor is comprises more advanced physical and operational characteristics than said first processor.

3. The data processing system of claim 2, wherein said interconnection means supports backward compatibility of said second, heterogenous processor with said first processor.

4. The data processing system of claim 3, wherein said interconnect means is coupled to a system bus and comprises a plurality of interrupt pins for connecting additional processors to said system bus.

5. The data processing system of claim 4, further comprising an enhanced system bus protocol that enables said backward compatibility.

6. The data processing system of claim 2, wherein said operational characteristics includes frequency, and said second, heterogenous processor operates at a higher frequency than said first processor.

7. The data processing system of claim 6, wherein said operational characteristics includes an instruction ordering mechanism, and said first processor and second processor utilizes a different one of a plurality of instruction ordering mechanism from among in-order processing, out-of-order processing, and robust out-of-order processing.

8. The data processing system of claim 2, wherein said more advanced physical topology are from among higher number of cache levels, larger cache sizes, improved cache hierarchy, cache intervention, and larger number of on-chip processors.

9. The data processing system of claim 1, further comprising a switch that provides direct point-to-point connection between said first processor and later added processors.

10. A method for upgrading processing capabilities of a data processing system comprising:
providing a plurality of interrupt pins from a system bus on a system planar to allow later addition of other processors;
enabling direct connection of a new, heterogenous processor to said system planar via said interrupt pins; and
providing support for full backward compatibility by said new, heterogenous processor when said new processor comprises more advanced operational characteristics to enable said data processing system to operate as a symmetric multiprocessor system.

11. The method of claim 7, wherein said providing support includes implementing an enhanced system bus protocol to support said new, heterogenous processor.

12. A multiprocessor system comprising:
a plurality of heterogenous processors with different operational characteristics and physical topology connected on a system planar;
a system bus that supports system centric operations;
interrupt pins coupled to said system bus that provide connection for at least one of said plurality of heterogenous processors;
an enhanced system bus protocol that supports downward compatibility of newer processors that support advanced operational characteristics from among said plurality of processors to processors that do not support said advance operation characteristics.

13. The multiprocessor system of claim 12, further comprising a switch that provides direct point-to-point connection between each of said plurality of processors and later added processors.

14. The multiprocessor system of claim 12, wherein said plurality of processors includes heterogenous processor topologies including different cache sizes, cache states, number of cache levels, and number of processors on a single processor chip.
